(19) United States
(12) Patent Application Publication
(10) Pub. No.: US 2020/0326011 A1
(43) Pub. Date: Oct. 15, 2020

(54) VALVE ACTUATOR WITH MULTIPLE MOTORS

(71) Applicant: TRI-TEC MANUFACTURING, LLC, Kent, WA (US)

(72) Inventors: Michael Douglas Williams, Kent, WA (US); Mark Scott Soldan, Tacoma, WA (US); Richard Lynn Cordray, Redmond, WA (US)

(21) Appl. No.: 16/846,051

(22) Filed: Apr. 10, 2020

Related U.S. Application Data
(60) Provisional application No. 62/832,801, filed on Apr. 11, 2019.

(51) Int. Cl. F16K 31/04; F16K 31/60

(52) U.S. Cl. CPC F16K 31/047; F16K 31/60; F16K 31/042

(57) ABSTRACT

Valve systems include a valve and a valve actuator assembly for operating the valve. The valve actuator assembly includes a first motor and a second motor mechanically coupled to an output of the valve actuator assembly via a differential gear system. The first motor, in operation, applies a first torque to the output via the gear system and the second motor, in operation, applies a second torque to the output via the gear system. The first and second torques are used to manipulate the valve. The first and second motors are operated independently or simultaneously in a first direction or a second direction that is opposite the first direction, in order to provide low speed and high torque when the valve is to be seated or unseated, and to provide high speed, low torque when moving the valve along its operational path.

### BACKGROUND

### Technical Field

The present disclosure generally relates to valve actuator assemblies, and more particularly, to valve actuator assemblies that include multiple motors to operate a valve at different speeds and torques.

### Description of the Related Art

Valve actuators are often used to open and close valves. Valve actuators can be used in a wide range of settings, including in waste water treatment plants, refineries, power plants, factories, and transportation vehicles, such as watercraft. Valve actuators apply force to move valves along a range of motion from an open position to a closed position and vice versa. The force applied to the valve by the valve actuator may be a force to create linear movement of the valve, or torque applied to a shaft or other rotating part coupled to the valve to create rotational movement of the valve. Valves typically have different specifications regarding the force or torque to be used to move the valve along their entire range of travel between the open and closed end positions. For example, large forces or torques are often used to unseat the valve from the closed position or seat a valve in the closed position, and comparatively little force is needed to move the valve through its range of travel between the seated end positions.

Known types of valve actuators include electric, hydraulic, and pneumatic valve actuators. When designing an actuator, the requirements for operating speed, sensing accuracy, and output force are typically satisfied by selecting one power source, such as an electric motor that is capable of performing all of the specified functions (e.g., speed sufficient to meet the timing requirements, torque sufficient to seat or unseat the valve, etc.). As such, known devices typically include a single motor or drive assembly and complex control systems that attempt to operate the valve without causing damage to the valve. For example, the control system instructs the actuator to stop creating the forces to open or close the valve at precise points when the valve is open or closed and they also control the valve so that it opens or closes in a desired time. Known control systems may stop motion based on several measured or sensed parameters, including valve position and applied torque. However, if the control system instructions are incorrect due to wear on the system over time (e.g., a change in operation conditions over time due to wear), incorrect sensed parameters, or programming malfunction, the incorrect amount of force may be applied to the valve at the incorrect time, resulting in damage to the valve.

Actuators with a multi-speed motor and controller have also been used so as to balance the above design choices. However, multi-speed motors add complexity, cost, and reliability challenges into the system. Reliability and safety are particular concerns, as systems that rely on valve actuators to open and close valves in the system may not operate, or may operate at significantly reduced efficiency, if the valve actuator is not operating as expected. Such failures may present significant safety risks. Alternatively, it is possible to include a gear shifting mechanism that would change gear ratios, thus changing the torque. However, such systems further add cost and complexity to valve actuator systems, as well as presenting reliability and safety issues.

### BRIEF SUMMARY

The present disclosure is generally directed to valve systems that include a valve and a valve actuator assembly. The valve actuator assembly includes a housing with two or more motors within the housing. The motors are mechanically coupled to an output via a differential gear system, which transfers torque from the motors to the output. A valve is mechanically coupled to the output, such that the motors open and close the valve via the differential gear system and output. The first motor can be selectively operated to output a first torque and the second motor can be selectively operated to output a second, different torque. The first and second torques correspond to first and second, different valve speeds, respectively. For example, a higher torque corresponds to a lower valve speed and lower torque corresponds to higher valve speed. The high torque, low speed configuration may be selected for precisely opening and closing the valve and the low torque, high speed configuration may be selected for moving the valve quickly through a majority of its path of travel.

The motors can operate independently or simultaneously to provide torque to the output. Each motor may be associated with an independent electronic controller for controlling operation of a respective motor. Alternatively, multiple motors may be associated with a single electronic controller that controls the operation of the motors independently. Using two motors, each with a specific purpose, reduces complexity in valve actuator systems while increasing control of movement of the valve, which ultimately reduces damage to the valve and other system components over time.

As described in further detail below, one or more embodiments of a valve actuator include: a housing; an output; a first motor arranged in the housing and coupled to the output; a second motor arranged in the housing and coupled to the output; and a differential gear system mechanically coupled between the first motor, the second motor, and the output, wherein the first motor is configured to apply a first torque in a first direction to the output via the differential gear system and the second motor is configured to apply a second torque in a second direction to the output via the differential gear system, the first torque being different than the second torque. In embodiments, the first direction is opposite the second direction. The first direction can also be the same as the second direction.

In some embodiments, the device further includes: a first electronic controller coupled to the housing and in electronic communication with the first motor, wherein the first electronic controller is configured to select a direction of the first torque output from the first motor (e.g., including selecting the first direction); a second electronic controller coupled to the housing and in electronic communication with the second motor, wherein the second electronic controller is configured to control a direction of the second torque output from the second motor (e.g., including selecting the second direction); and a hand wheel coupled to the housing and mechanically coupled to the differential gear system.

In one or more embodiments, the device includes: a valve mechanically and physically coupled to the output and configured to move between an open position and a closed position, wherein the first motor is configured to output the first torque to the valve to seat the valve in the closed position and to unseat the valve from the closed position, and the second motor is configured to output the second torque to the valve to move the valve between closed position and the open position; the first motor and the second motor being configured to simultaneously apply the first torque and the second torque; the first torque corresponding to a first speed and the second torque corresponding to a second speed different from the first speed, such as the first torque being greater than the second torque and the first speed being less than the second speed.

One or more embodiments of a device may include: a housing; an output; a first motor configured to produce a first torque in a first direction; a second motor configured to produce a second torque that is different than the first torque in a second direction; and a differential gear system arranged in the housing and mechanically coupled to the first motor, the second motor, and the output, the differential gear system configured to receive the first torque from the first motor and the second torque from the second motor, and apply a third torque in a third direction to the output.

In some embodiments, the device further includes: the first direction being opposite to the second direction; the third direction being the first direction; the device further comprising a first electronic controller coupled to the housing and in electronic communication with the first motor; the first electronic controller also being in electronic communication with the second motor; and the device further comprising a second electronic controller coupled to the housing and in electronic communication with the second motor.

One or more embodiments of a device include: a valve; a valve actuator that includes: a housing; an output coupled to the valve; a first motor arranged in the housing and coupled to the output; a second motor arranged in the housing and coupled to the output; and a differential gear system in the housing and mechanically coupled between the first motor, the second motor, and the output.

In some embodiments, the device further includes the first motor being configured to apply a first torque to the output via the differential gear system and the second motor being configured to apply a second torque to the output via the differential gear system, the first torque being different than the second torque.

### BRIEF DESCRIPTION OF THE SEVERAL VIEWS OF THE DRAWINGS

For a better understanding of the embodiments, reference will now be made by way of example only to the accompanying drawings. In the drawings, identical reference numbers identify similar elements or acts. In some drawings, the sizes and relative positions of elements are not necessarily drawn to scale. For example, the shapes of various elements and angles are not necessarily drawn to scale, and some of these elements may be enlarged and positioned to improve drawing legibility. In other drawings, the size and relative position of elements are exactly to scale.

FIG. 1 is a perspective view of an embodiment of a valve actuator with a plunger according to the present disclosure.

FIG. 2 is a perspective view of an embodiment of a rotational valve actuator according to the present disclosure.

FIG. 3 is a cross-sectional view of an embodiment of a valve actuator with a rotating drive shaft and a controller according to the present disclosure.

FIG. 4 is a cross-sectional view of an embodiment of a valve actuator with a plunger that translates along a linear axis and a controller according to the present disclosure.

### DETAILED DESCRIPTION

For most valves, there is a defined path of travel for the valve between two end points. For example, if the valve is in an open position, a force can be applied to the valve (e.g., via an actuator or hand wheel controlling the valve) to close the valve. The valve is moved from the first open position and travels along its path until it is seated in a second, closed position. The movement of the valve along its path may occur through translation or rotation of the valve. As such, when designing a valve actuator to control a valve, there are several design considerations. For example, more torque or force is generally needed to seat a valve or to remove a valve from its seated position (e.g., to unseat a valve) than is needed to move the valve through most of its travel path due to the forces associated with seating the valve, which may include pressure along the line in which the valve operates, close tolerances between the valve body or seal and the disk (which prevents leakage of the valve in the closed, seated position), or other issues of the mechanical configuration of the valve. In some cases, the preferred torque to seat the valve can be upwards of 10 times the preferred torque to move the valve along its travel path.

In addition, the design specifications of certain systems that utilize valves and valve actuators typically include a preferred time of operation. In some cases, the valve is preferably moved along its travel path from the open position to the closed position in 30 seconds, while in other cases, the operational time of the valve may be as little as 2 seconds or less.

Additionally, the inertial properties of the motors or other sources of torque are considered in designing the actuator. For example, when a flywheel of a motor is inactivated, the flywheel may continue to spin because of the inertia in the flywheel, which will continue carrying the valve through its path after the motor is inactive. Such inertial forces can result in damage to the mechanical components (e.g., the valve disk), or even jamming of the valve in the seated, closed position.

Further, there is a relationship between the operational speed of a single speed motor (e.g., revolutions per minute) and its action on the valve through selected gearing components, wherein motor power and speed, as well as gear differential or ratios, can be modified to produce a given output. Thus, although an electric motor could be coupled with a reduction gear set to convert high motor revolutions per minute to a lower revolutions per minute that is more suitable for some operations of the valve, single speed motors and associated reduction gears are often not capable of producing the appropriate torque for efficiently operating the valve. For example, if a high speed, low torque motor and gear arrangement is used, the motor may be able to move the valve along a majority of its path, but may not produce enough torque to appropriately seat the valve. Similarly, if a low speed, high torque motor is used to accommodate seating the valve, the same motor may not be able to appropriately move the valve along its path of travel between the seated positions (e.g, between the open and closed positions).

In light of the above considerations, single motor actuators are typically designed with large, heavy motors that produce sufficient torque for opening and closing the valve while also operating at a high enough revolutions per minute to move the valve quickly through its path between the open and closed positions, which results in actuators with heavy, large motors that are not ideally suited for any of the necessary operations. In other words, a single motor is selected that is capable of meeting torque and speed specifications for operation of a valve. As such, if the preferred closing time of a valve is 2 seconds, a very fast gear and motor combination that is able to produce high torque has traditionally been preferred in order to satisfy the torque and speed specifications of the system.

The issues with this approach are many, including increased cost and weight of the actuator, as well as a decrease in reliability. The reliability issues arise in part because if the single motor does not function properly, the actuator may stop operation altogether, or be significantly hindered in operation. Further, if the timing of the operation of the single motor is not accurately taken into consideration, the inertia of the motor can cause the valve disk to slam into its seat, which can not only cause damage to the valve components, but can also jam the valve in the seated position.

For example, the distance where high torque is preferred is in seating a valve, which may involve a distance of as little as 0.10 inches. In addition, in a system that preferably closes a valve in two seconds, an actuator using a single speed (e.g., constant operational speed) motor travels this distance in a fraction of a second. As such, at these minute levels, the valve is difficult to control precisely with a single, high torque, high speed motor and gear combination, especially considering the inertial motion of the motor and valve. These difficulties often result in improper seating of the valve, which can damage or jam the valve components. Addressing these considerations increases complexity in control units that are implemented to control the valve.

It is contemplated in the present disclosure to utilize two or more motors in an actuator to achieve several benefits over prior systems while minimizing the above disadvantages. A first motor is preferably a high torque, low speed motor and gear combination for seating or unseating the valve at the ends of the path of travel of the valve. The second motor is preferably a low torque, high speed motor and gear combination for moving the valve through a majority (e.g., up to 95% or more) of its path of travel between the end points. Each of these motors would generally be smaller in size and power than a single motor capable of accomplishing the combined functions. As such, control of the inertia from the motors is more manageable and predictable. Moreover, the motors can be operated in opposite directions (e.g., one in normal, forward operation, and the other in reverse) such that one motor can provide a braking function to prevent the inertia from the other motor from jamming the valve into the seat, or to slow down the approach of the valve during seating. Similarly, both motors can be operated in the same direction in order to provide more speed for moving the valve through its main path between end points. As such, with two or more motor and gear combinations, control of the valve can be accommodated to particular design scenarios.

By using two or more motor and gear combinations, the beneficial effects of each motor can be realized during operation, such that the movement of the valve through the majority of its path can be accomplished in less time, which provides more time for the seating operation, which can be controlled more precisely. For example, in an embodiment where the operational time is two seconds, multiple motors of the actuators described herein can be operated in the same direction during the main path of travel to increase speed, such that the main path of travel can be accomplished in one second. This leaves one second for seating, which is a significant increase over single motor systems, as described above, in which only fractions of a second, such as 0.1 seconds, may be available for seating the valve. Providing more time for the seating operation enables closer control, and allows the controller, sensors, and software associated with each motor to adjust operation of the motors to properly seat the valve. This additional time also allows the valve to move at a slower speed, which results in lessened inertia, or for the control system to otherwise take inertia into account. For example, during seating, if the control system detects that the valve is moving too quickly towards the seat, one of the motors can be operated in reverse to act as a limiting force (e.g., a brake) on the forward motion from the other motor, allowing the valve to seat properly, without damage or jamming. Finally, using two or more motors increases reliability, as the loss of one motor does not disable the system.

Additional advantages of the embodiments of the present disclosure include that the selection of which motor and gear combination is used can be made by operating the selected motor alone, such as through an electrical contact in the case of an electric motor. As such, embodiments of the present disclosure do not require gear switching and associated meshing mechanisms, clutches, or other like devices, which reduces complexity in the overall system, and increases reliability. Because different valves have different characteristics, such as preferred operational torques and speeds, the motors and associated gearing disclosed herein can be adapted to the particular valve characteristics. As stated above, the valve can be controlled with precision at the ends of travel by moving more slowly and with greater control proximate the ends while still operating quickly enough mid-travel to meet operating speed requirements.

Further, the overall size and weight of the actuator can be reduced because the closing torque and speed requirements are less limiting design factors than with single motor actuators. Rather, small, more effective motors and corresponding gear combinations can be selected for use based on valve characteristics. Some valves, such as triple-offset butterfly valves, are torque seated and utilize precision control of the valve during seating based on measurement of applied torque. Reducing the speed of output at the ends of travel not only optimizes the use of the power of a motor, but also increases the amount of time the actuator spends in a region where it may be important to measure position or torque. This increased time allows designers to implement sensors, measurement systems, devices such as analog to digital converters, microcontrollers, and software algorithms that are less complex, less costly, and less technically challenging than equivalent systems with a single motor that have to perform similar functions much more quickly.

The present disclosure is generally directed to valve actuators with two or more motors and associated gearing combinations for applying torque to an output of the valve actuator for operating a valve coupled to the output. Preferably, each motor and associated gearing combination produces different torques, wherein the torque is transferred to the output through a planetary differential gear system. The combination of different torques in selected directions allows for efficient and controlled manipulation of the valve, as described herein.

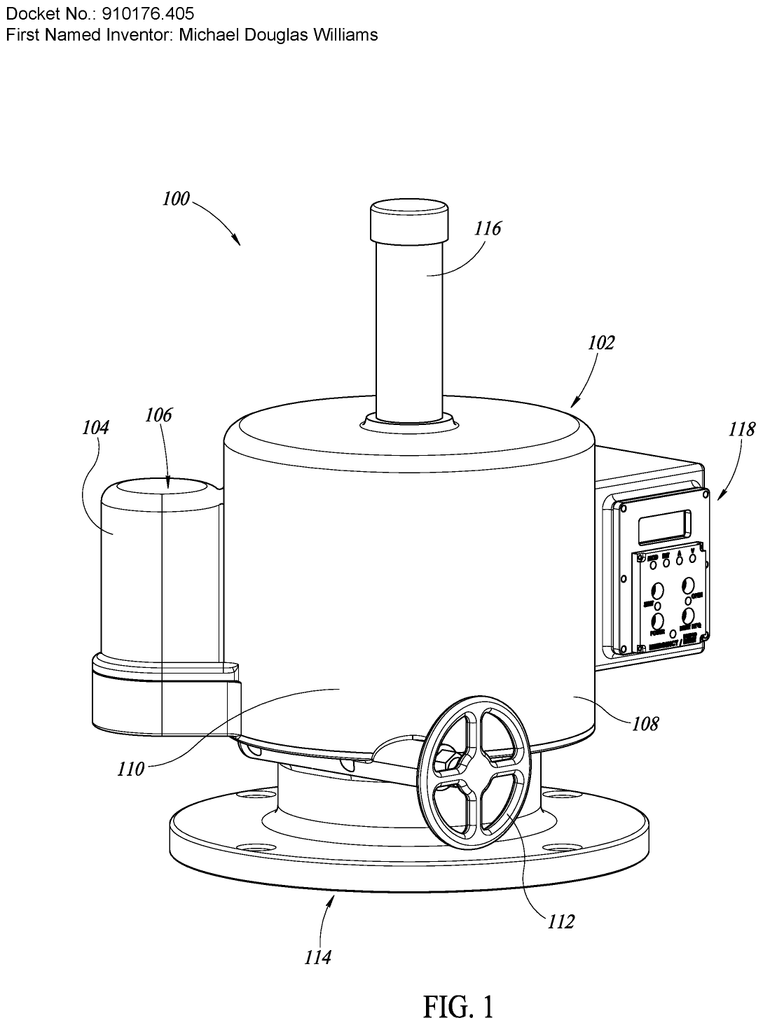

FIG. 1 illustrates an embodiment of a valve actuator 100, which may also be referred to as an actuator or a valve actuator assembly. The valve actuator 100 includes a housing 102 with a first motor 104 coupled within a first portion 106 of the housing 102. The first portion 106 is integrated with a second portion 108 of the housing 102, in which a second motor 110 is arranged. In other words, the second motor 110 is within the second portion 108 of the housing 102 with the second portion 108 being adjacent to the first portion 106. In the illustrated embodiment, the first portion 106 and the second portion 108 are generally cylindrical in nature, although other shapes are expressly contemplated herein (e.g., square or rectangular).

In an embodiment, the valve actuator 100 includes a hand wheel 112, which may also be referred to as a hand wheel assembly. In other embodiments, multiple hand wheel assemblies may be included. Each of the first and second motors 104, 110 and the hand wheel 112 are mechanically coupled to a differential gear system within the housing 102, which in an embodiment, is a planetary differential gear system. The differential gear system receives several input forces and outputs a single unified force. For example, it is possible to operate the first motor 104, the second motor 110, and the hand wheel 112 at the same time, with the force output from each received by the differential gear system. The differential gear system combines these forces and transfers them as a single output force to an output 114 of the actuator 100.

In an embodiment, each of the motors 104, 110 are single speed motors, meaning that the rate of operation, and thus the output from the motor, is generally constant when the motors are operational. In operation, the first motor 104 and associated gear assembly can be operated to output a first torque T1 at a first speed S1 to the differential gear system in either a first direction, or a second opposite direction (e.g., forward or reverse). Similarly, the second motor 110 and associated gear assembly can be operated to output a second torque T2 at a second speed S2 to the differential gear system in either the first direction or the second direction. Finally, the hand wheel 112 can be operated manually to output a third torque T3 at a third speed S3 to the differential gear system in either the first direction or the second direction. In an embodiment, each of the torques T1, T2, T3 and speeds S1, S2, S3 are different, while other embodiments, one or more are the same, or they are all the same. Each of these inputs T1, T2, T3 and S1, S2, and S3, are received by the differential gear system, which combines them into a single output torque OT and a single output speed OS.

In some embodiments, the first motor 104 and gear combination is a low torque, high speed motor and gear combination and the second motor 110 and gear combination is a high torque, low speed motor and gear combination. The second torque T2 output from the second motor 110 may be up to ten times greater than the torque T1, or more. As such, in various embodiments, the torque T2 is at least two times, three times, four times, five times, six times, seven times, eight times, nine times, or ten times, or more, greater than the second torque. The speed S1 output the first motor 104 may be considerably less than the speed S2 output from the second motor 110. For example, the speed S2 may be ten times, twenty times, thirty times, forty times, or fifty times, or more, greater than the first speed S1, in some embodiments. The above torque and speed ranges include integral and fractional components between any of the ranges listed. For example, the second speed S2 may be fifteen times greater than the first speed S1, or may be 25.4 times greater. Alternatively, the first motor 104 and gear combination can be high torque, low speed, and motor and gear combination and the second motor 110 and gear combination can be a low torque, high speed motor and gear combination. Further, in an embodiment, the actuator 100 includes more than two motors, such as three, four, five, six, or more motors. In such embodiments, each of the motors are preferably single speed motors, such that the motor and gear combinations have different torque and speed outputs, and the differential gear system is configured to combine them into a single output torque and speed.

As can be appreciated from the discussion above, each of the motors, such as motors 104 and 110 and the hand wheel 112 include an output that is mechanically coupled to the differential gear system through one or more gears, rings, pinions, drive shafts, axles, and the like. The differential gear system may include any such devices mechanically coupled together in order to combine the torques and speeds output from the motors 104, 110 and the hand wheel 112 into the single combined output torque OT and output speed OS. The output torque OT and the output speed OS act on the plunger 116, which is mechanically coupled to the differential gear system. Further, each of the motors 104, 110 and the hand wheel 112 can act on the differential gear system and the plunger 116 independently (e.g., only one is operational at a time) or simultaneously (e.g., both motors 104, 110 are operational simultaneously or one motor 104, 110 and the hand wheel 112 are operational simultaneously, or all three devices 104, 110, 112 are operational simultaneously). In this way, the torque and speed applied to the plunger 116, and thus to a valve coupled to the output 114 and the plunger 116 of the actuator 100, can be controlled, as described herein.

The actuator 100 described with reference to FIG. 1 may be used with a rising stem valve, such as a gate valve. However, embodiments of the present disclosure include two or more motors for a single actuator configured for use with other types of valves as well, such for a quarter-turn valve.

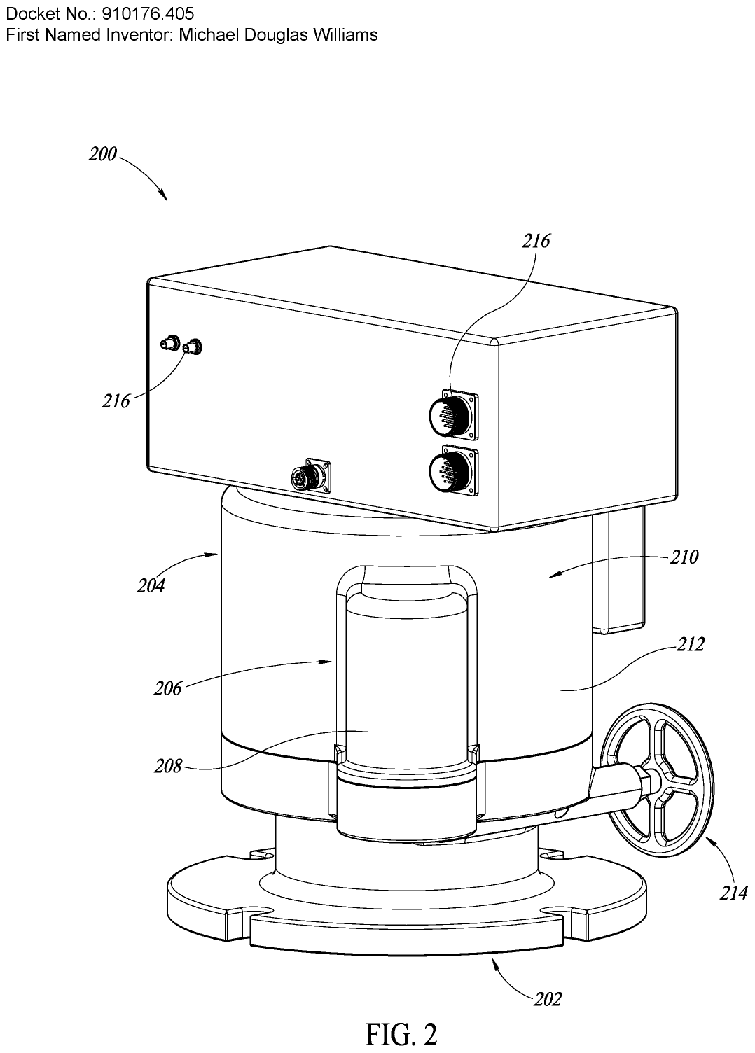

FIG. 2 illustrates an embodiment of rotary actuator 200 according to the present disclosure. In some embodiments, the actuator 200 is used with a quarter-turn valve. As such, the actuator 200 may not include a plunger that translates along an axis, but rather, an output 202 of the actuator 200 rotates in order to provide rotational motion of a valve coupled to the output 202 between an open and closed position along a defined rotational path of the valve. In other respects, the actuator 200 can include similar features to the actuator 100 described above with reference to FIG. 1. For example, the actuator 200 includes a housing 204 which includes a first portion 206 and a second portion 210 integrated with each other as a single unit (e.g., the first portion 206 and the second portion 210 are adjacent and interconnected as a unitary piece). A first motor 208 is coupled to the housing 204 within the first portion 206. A second motor 212 is coupled to the housing 204 within the second portion 210. In one or more embodiments, the actuator 200 includes a hand wheel 214. Each of the first motor 208, the second motor 212, and the hand wheel 214, are mechanically coupled to a drive assembly, such as a differential gear system, which is mechanically coupled to the output 202 for connection to a valve.

The differential gear system, which may be a planetary differential gear system, combines torque and speed output by each of the motors 208, 212 and the hand wheel 214 into a single output torque and speed. Preferably, each of the inputs from the motors 208, 212 and the hand wheel 214, and the associated gearing, are different (e.g., different torques and speeds) although the same is not necessarily required. The single output torque and speed rotates internal gearing at the output 202, which when connected to a valve through a valve stem, rotates the valve. As with the actuator 100, the motors 208, 212 and the hand wheel 214 of the actuator 200 can be operated in the same direction, or in different directions, so as to provide control over the rotation at the output 202.

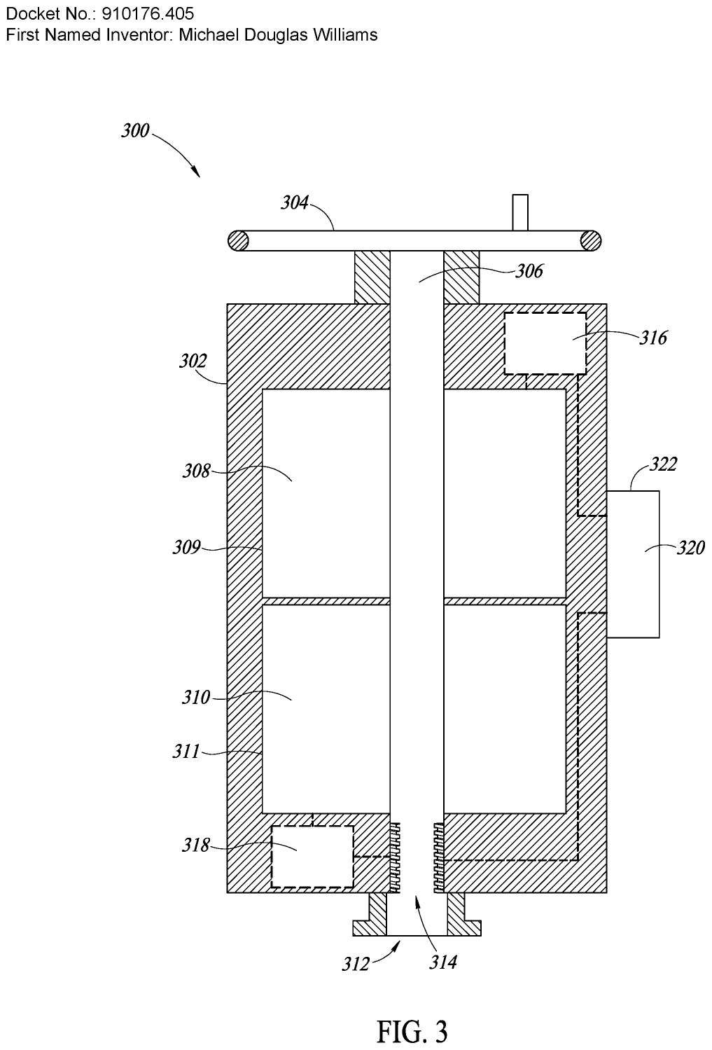

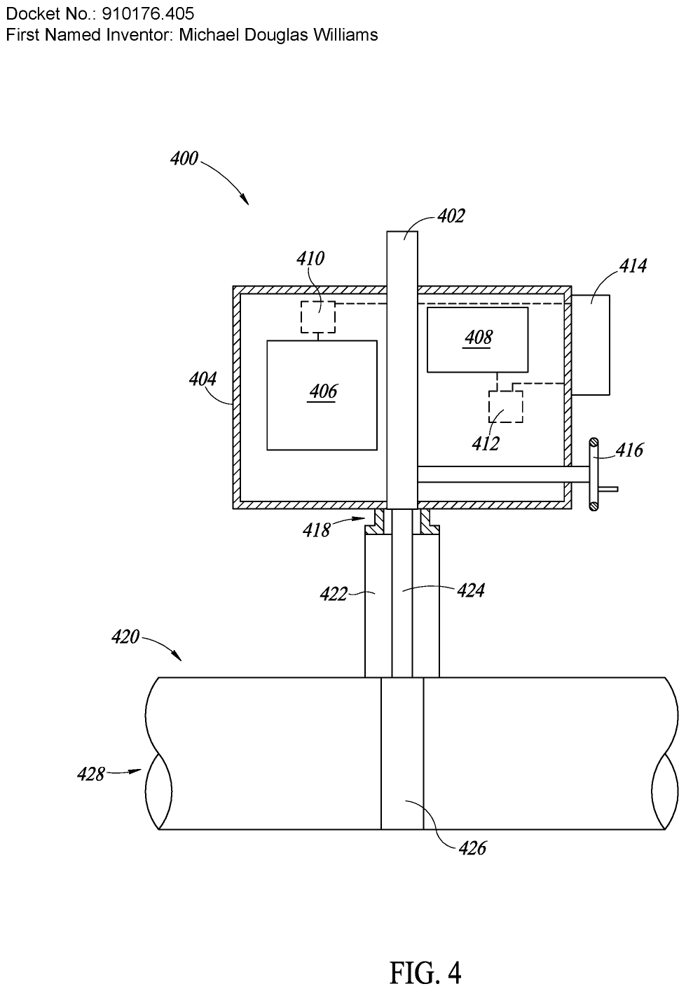

In an embodiment, the housing 204 further includes a plurality of inputs 216, which may be used to connect the valve actuator 200 to various external structures or components within a system. For example, in some embodiments, one of the plurality of inputs 216 transmits power to the valve actuator 200, and more specifically, to the motors 208, 212 and a controller, as described below with reference to FIGS. 3 and 4. Still further, a different one of the plurality of inputs 216 may establish an electrical or communicative connection between the valve actuator 200 and other actuators or controllers within a system. In yet further embodiments, various sensors, such as temperature, water, or humidity sensors may be coupled to the one of the inputs and in electronic communication, either wired or wirelessly, with the controller in order to provide sensor readings regarding the internal or external conditions of the valve actuator 200. In an embodiment where the motors 208, 212 are pneumatic or hydraulic motors, one or more of the plurality of inputs 216 may be used to facilitate a connection with various hydraulic or pneumatic lines to provide pressurized fluid, such as air, gas, or hydraulic fluids, to the drive device motors 208, 212.

FIG. 3 illustrates an embodiment of an actuator 300, which is a rotational actuator. The actuator 300 includes a housing 302, wherein a hand wheel assembly 304 is coupled to an internal drive shaft 306. A first motor 308 is adjacent to a second motor 310, and both are arranged concentrically around the drive shaft 306. In other words, the first motor 308 and the second motor 310 are aligned along the drive shaft 306. In some embodiments, the first motor 308 and the second motor 310 are aligned relative to each other, but are offset from the drive shaft 306 and mechanically connected to the drive shaft 306 by a differential drive assembly, which may contain a plurality of gears, pinions, or other like devices integrated and intermeshed together. In one or more embodiments, the motors 308, 310 are coaxial. In yet further embodiments, the first motor 308 and the second motor 310 are not aligned and are offset from each other, such as the first motor 308 generally being positioned above the second motor 310, but with a distance between an outermost edge 309 of the first motor 308 and an outermost 311 edge of the second motor 310.

While the first motor 308 and the second motor 310 are illustrated as being the same size, it is to be appreciated that the first motor 308 and gear combination may be larger, high torque, low speed and the second motor 310 and gear combination may be a smaller, low torque, high speed, or vice versa, as described herein. Moreover, the first motor 308 and gear combination may comprise two motors, and the second motor 310 and gear combination may comprise two motors, for a total of at least four motors in the actuator 300, in addition to the hand wheel assembly 304. In an embodiment, each of the four motors are spaced equidistant about the drive shaft 306, or all aligned concentrically along the drive shaft 306, or offset from each other about the drive shaft 306. Each of the motors 308, 310 and associated gear combinations are mechanically coupled to the drive shaft 306 through a differential gear assembly such that the speed and torque output from the motors 308, 310 and associated gear combinations is transferred to the drive shaft 306, as described herein. Moreover, the hand wheel assembly 304 can be used to rotate the drive shaft 306 in either direction. As such, the hand wheel assembly 304 can be used to manually add torque and speed to turn the drive shaft 306, or can be used to act as a manual brake against rotation of the drive shaft 306.

In some embodiments, the first motor 308 is a low speed electric motor, the first motor 308 and gear combination is high torque, low speed, the second motor 310 is a high speed electric motor, and the second motor 310 and gear combination is low torque, high speed. As such, the electric motors 308, 310 create a rotating magnetic field which attracts a magnetized rotor based on alternating single phase or 3 phase alternating current, which is input to the electric motors 308, 310 from an external source and is passed through multiple windings or poles in the motors 308, 310 to create a variable magnetic field in the respective motor stator. For example, the first motor 308 may be an 1800 revolutions per minute (“RPM”) motor with a gear combination to produce high torque and low speed. The second motor 310 may be a 3600 RPM motor with a gear combination to produce low torque and high speed. The actuator 300, containing motors 308, 310 and associated gearing combinations, is configured to operate valves from 0.25 RPM to 75 RPM, wherein the speed is controlled by gearing. The first motor 308, operating at 1800 RPM (or 30 revolutions per second) includes a 2 pole stator when using 60 Hertz (“Hz”) alternating current (“AC”) power, in some embodiments. The number of poles or the frequency of the applied voltage, or both, can be changed to vary the speed of either motor 308, 310.

As described above, another relevant design consideration is that the power of a motor is directly related to a size of the motor. For example, in general, the more power that is to be produced by a motor, the larger the motor will be because more power requires stronger magnetic fields, more space for larger internal components, and more materials, among others. In existing actuators with a single motor, high torque is produced by an electric motor operating at constant speed and gear reductions to operate a valve at low speed.

For example, a single motor actuator with a 0.125 horsepower (“HP”) motor operating at a speed of 3600 RPM (e.g., without gearing) can operate with a quarter turn butterfly valve with 1300 ft-lbs of torque by operating the valve at 0.5 RPM according to the equation Power (typically HP)=(Torque×RPM)/K where K is a constant. If torque is in ft-lbs and power is in horsepower, then K is 5252. To operate a multi-turn valve at a higher speed, such as 24 RPM, a single motor actuator may need a motor with 1.5 HP, assuming the same motor operating speed (3600 RPM), to get only 350 ft-lbs of torque. As such, single motor actuators can include large, heavy motors to meet valve operational characteristics. However, embodiments of the present disclosure that include two motors and associated gear combinations, as above, can meet the same valve operational characteristics, but with smaller, light motors.

In some cases, the combination of output torque and speed from each of the motors 308, 310 and the associated gearing may result in the larger of the two motors 308, 310 causing the smaller of the two motors 308, 310 or the hand wheel assembly 304 to spin in reverse, effectively negating the effect of the motors 308, 310 on the drive shaft 306. In such cases, an anti-back drive component may be included in any or all, of the motors 308, 310 and the hand wheel assembly 304, and specifically at an output of each of the individual drive shafts of the motors 308, 310 and at an output of the hand wheel assembly 304.

In one or more embodiments, if it is determined that one of the motors 308, 310 is causing the other motor or the hand wheel assembly 304 to spin in reverse, a gearing combination can be selected to prevent such reverse spinning. However, in one or more embodiments, the design of the differential gear assembly will account for the potential of back spinning, and will be designed to accommodate and avoid the same.

The actuator 300 includes a mounting assembly 312, which can be used to fixedly or removably couple the actuator 300 to a valve, among other external structures. The mounting assembly 312 can include one or more bearings, output shafts, chucks, couplers, split rings, clamps, brackets, set screws, fasteners, pins, and the like to facilitate the temporary or permanent coupling of the actuator 300 to an external structure, such as a valve, connector, or support. The actuator 300, and more specifically, the mounting assembly 312, further includes an output 314, which may be a gear, a series of ribs and channels, teeth, splines, or other structures. The output 314 is connected to the drive shaft 306 of the actuator 300 and the valve, and more specifically the valve stem, in an embodiment, in order to transfer force and torque from the motors 308, 310 to the valve or other external structure via rotation of the output 314 about its axis.

The actuator 300 further includes a first electronic controller 316 coupled to the housing 302 and in electronic communication with the first motor 308. A second electronic controller 318 is coupled to the housing 302 and in electronic communication with the second motor 310. While FIG. 3 illustrates one electronic controller associated with each motor 308, 310 in the actuator 300, in some embodiments, all of the motors, such as motors 308, 310, are controlled by a single electronic controller.

The electronic controllers 316, 318 control an output of the motors 308, 310. In other words, the first electronic controller 316 provides a signal to the first motor 308 to activate the motor 308 in either a first direction or a second, opposite direction. Similarly, the first electronic controller 316 can output a second signal to stop operation of the first motor 308. The second electronic controller 318 operates similarly with respect to the second motor 310. Because the motors 308, 310 may operate independently (e.g., only one operational at a time), the electronic controllers 316, 318 selectively send signals to the respective motors corresponding to operation of the motors 308, 310. In an embodiment, each of the electronic controllers 316, 318 are in electronic communication with each other, either via one or more wires, or wirelessly, as described herein, such that the controllers 316, 318 can coordinate transmission of operation signals to the motors 308, 310.

Such signals may be generated from a controller 320 in a controller housing 322 (which may also be referred to herein as a user interface 322) coupled to the housing 302. The controller 320 is in electronic communication with each of the electronic controllers 316, 318, such that the controller 320 can automatically control the operation of the motors 308, 310 via the electronic controllers 316, 318. In some embodiments, a connector extends from the housing 322 for reading and receiving data via direct electrical connection between the controller 320 and an external device, such as a computer, for example. In an embodiment, the controller 320 includes a display and an input device, such as an input pad, on the front of the controller housing 320. The input device can include one or more buttons, keyboards, touch pads, control modules, and/or peripheral devices for user input, such as for initiating a control sequence associated with opening and closing the valve associated with the actuator 300. Moreover, the controller 320 can include various lights, such as those powered by light emitting diodes, among others, for indicating a status of the controller 320 and the actuator 300, to a user.

In one or more embodiments, the controller 320 is located external to actuator 300 (e.g., located remote from a motor, gearing, hand wheel, or other components of the actuator 300) and electrically and communicatively coupled to the valve actuator assembly 100 by wires or through wireless transmission protocols, such as Wi-Fi or Bluetooth® protocols, for example.

The controller 320 will generally include and as further referenced below, one or more central processing units, processing devices, microprocessors, digital signal processors (DSP), application specific integrated circuits (ASIC), readers, and the like. To store information, the controller 320 can also include one or more storage elements, such as volatile memory, non-volatile memory, read-only memory (ROM), random access memory (RAM), and the like. The storage elements can be coupled to the controller 320 by one or more busses. Example displays include LCD screens, monitors, analog displays, digital displays (e.g., light emitting diode displays), touch screen displays, or other devices suitable for displaying information. The term “information” is used broadly to include, unless the context clearly dictates otherwise, one or more programs, executable code or instructions, routines, relationships (e.g., torque versus displacement curves, sensor signals versus valve positions, etc.), data, operating instructions, and the like, or combinations thereof. For example, information may include one or more torque settings (or other force settings) suitable for opening and closing valves of various sizes and operational requirements. In some embodiments, information can be transmitted between valve actuators, between an installed controller and a replacement controller, between a controller and a computer, across a network, and the like. Such communication may be accomplished via direct, wired connections or wirelessly, such as through use of Wi-Fi® or Bluetooth® transmission protocols and antennas, receivers, transceivers, and the like, corresponding to the same.

The actuator 300 is suitable for use in a range of different environments, including non-corrosive environments, corrosive environments, magnetic environments, non-magnetic environments, moist environments, marine environments, or combinations thereof, and as such, the actuator 300 may be formed from a variety of different metals, which may have the above properties, or the actuator 300 may coated with one or more coatings to achieve performance in the above conditions. Marine environments are especially harsh because of the abundance of moisture and corrosive substances, such as salt water. The compact and robust actuator 300 is especially well suited for use in ocean liners, ships, including military ships and submarines with limited mounting space for a valve system. In some embodiments, the actuator 300 may be used in civilian or military watercraft (e.g., floating vessels, boats, ships, submergible vehicles such as submarines, and the like). The illustrated actuator 300, which may be a marine valve actuator assembly, can be submerged for an extended length of time (e.g., at least 10 minutes, at least 30 minutes, or more than an hour in some embodiments) without appreciably compromising performance, damaging internal components, and the like. For example, in an embodiment, the actuator 300 includes hermetic or watertight seals, or both, at the couplings between components of the actuator 300, such as through the use of gaskets, although the same can be accomplished without using gaskets in other embodiments. Various components of the actuator 300 can be modified or removed based on the surrounding environment, if needed or desired.

In an embodiment, the valve system coupled to the actuator 300 may include one or more sensors to evaluate operation of the valve. In some embodiments, a sensor is mounted or adjacent to a connector and is communicatively coupled to the controller 320, as described in U.S. Pat. No. 8,342,478, the entirety of which is incorporated herein by reference. In other embodiments, the sensor can be incorporated into the housing 302, the mounting assembly 312, or any other suitable component or subassembly of the actuator 300.

Preferably, the sensor is capable of sensing various different operating features and forces present during operation of the valve. In one embodiment, the sensor is an angular position sensor that detects and sends one or more signals indicative of the angular position of a valve member. In other embodiments, the sensor also detects the amount of force (e.g., torque) applied to the valve via the drive shaft 306 and the motors 308, 310. The sensor can detect the torque applied to the drive shaft 306 to cease rotation of the valve and also detect the position of the valve while the torque is being applied. In some embodiments, various forces, such as lateral forces, axial forces, sealing forces, the force applied to the drive shaft 306 at or by the motors 308, 310, as well as the force the connector applies to the valve may be detected.

FIG. 4 illustrates an embodiment of an actuator 400, which provides for movement of a plunger 402 along a linear axis. The actuator 400 includes a housing 404, a first motor 406, and a second motor 408. Each of the motors 406, 408 are communicatively coupled to a corresponding electronic controller 410, 412, respectively. The electronic controllers 410, 412 are communicatively coupled, either wired or wirelessly, to a controller 414. A hand wheel assembly 416 is mechanically coupled to the plunger 402. More specifically, each of the motors 406, 408 and the hand wheel assembly 416 are mechanically coupled to the plunger 402 through a differential drive assembly which may include, for example, a plurality of intermeshed and interconnected gears, as described herein. The motors 406, 408 and the hand wheel 416 provide torque and speed to translate the plunger 402 along its axis, as described with reference to FIG. 1. Each of the above described features may operate similarly, if not identically, to the same features described above with reference to FIGS. 1-3.

Importantly, however, the motors 406, 408 are not aligned relative to one another. Rather, the motors 406, 408 are in spaced relationship relative to plunger 402 and share no other specific relationship relative to one another. In an embodiment, the motors 406, 408 are on opposite sides of the plunger 402, while in other embodiments, the motors 406, 408 are both on the same side of the plunger. In yet further embodiments, the housing 404 includes a plurality of motors, such as three, four, five, six or more motors, that are each spaced around the housing 404 and mechanically coupled to the differential drive assembly to translate the plunger 402.

A valve assembly 420 is physically coupled to a mounting assembly 418 of the actuator 400 by a connector 422. The valve assembly 420 includes a valve stem 424 mechanically coupled to the plunger 402. As such, when the motors 406, 408 drive the plunger 402 via the differential drive assembly, the translation of the plunger 402 results in translation of the valve stem 424 and thus, translation of the valve 428 along passageway 428. In operation, the first motor 406 is activated by a signal from the external controller 414 to the first electronic controller 410 that is transmitted from the first electronic controller 410 to first motor 406. The first motor 406 outputs, via a gearing combination of the first motor 406, a first torque at a first speed to the valve 428 when the valve 428 is proximate a seated position, as shown. The first torque is preferably a comparatively larger torque at a slower speed to unseat the valve 428. Once the valve 428 is unseated, operation of the first motor 406 can continue, if desired to increase operational speed, or can be terminated. Then, the second motor 408 is activated, via the electronic controller 412, which receives a signal from the controller 414, to continue translation of the valve 428 through a majority (e.g., over 90% and in an embodiment, over 99%) of its path of travel. The second motor 408 and corresponding gear combination output a second torque at a second speed, wherein the second torque is preferably less than the first torque and the second speed is preferably greater than the first speed.

In some embodiments, once the valve 428 reaches the opposite end of its travel path, or is proximate to the opposite position, the second motor 408, via electronic controller 412 and controller 414, terminates operation, and the first motor 406 is activated, or continues operation to adjust the valve 428 position at the end of the travel path. It is to be appreciated that although the above description corresponds to moving the valve from a seated, closed position to an open position, the same procedure can be performed in reverse to move the valve from the open position to the seated closed position, with the larger torque being used to move the valve from the open position and to seat the valve in the closed position.

As such, the actuators described herein can include multiple motors and gear combinations that each provide different torques and speeds to a differential gear assembly, so as to provide more torque and less speed for control while beginning or ending the path of travel (e.g., seating the valve) and less torque and more speed for more quickly moving the valve through its major path of travel. Such actuators are advantageous over single motor systems because of reduced weight, size, and cost and because of the increase in reliability due to redundancy in the number of motors in the system. Further, the multiple motor actuators described herein enable more control over the valve during seating so as to reduce damage to the valve or valve seat as well as to reduce the potential for jamming the valve in the seat. Finally, the embodiments described herein are considerably less complex than existing systems.

In the above description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with valve actuator assemblies and methods and electric, hydraulic, or pneumatic motors have not been shown or described in detail to avoid unnecessarily obscuring descriptions of the embodiments.

As used herein, the term “valve” is broadly construed to include, but is not limited to, a device capable of regulating a flow of one or more substances by opening, closing, or partially blocking one or more passageways. For example, a valve can halt or control the flow of a fluid (e.g., a liquid, a gas, or mixtures thereof) through a conduit, such as a pipe, tube, line, duct, or other structural component (e.g., a fitting) for conveying substances. Valve types include ball valves, butterfly valves, globe valves, plug valves, gate valves, guillotine valves, and the like.

Further, as used herein, unless the context clearly dictates otherwise, the term “gear” is broadly construed to include a device for transferring force (e.g., torque, etc.) from one object to another, and includes, but is not limited to, devices with structures such as ribs, channels, teeth, splines, protrusions, extensions, projections, or other structural components to accomplish such transfer by meshing with another device having corresponding structures.

Unless the context requires otherwise, throughout the specification and claims which follow, the word “comprise” and variations thereof, such as, “comprises” and “comprising” are to be construed in an open, inclusive sense, that is as “including, but not limited to.” Further, the terms “first,” “second,” and similar indicators of sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The relative terms “approximately” and “substantially,” when used to describe a value, amount, quantity, or dimension, generally refer to a value, amount, quantity, or dimension that is within plus or minus 5% of the stated value, amount, quantity, or dimension, unless the content clearly dictates otherwise. It is to be further understood that any specific dimensions of components provided herein are for illustrative purposes only with reference to the exemplary embodiments described herein, and as such, the present disclosure includes amounts that are more or less than the dimensions stated, unless the context clearly dictates otherwise.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied outside of the valve actuator assembly context, and not necessarily the exemplary valve actuator assembly systems, methods, and devices generally described above.

The foregoing detailed description has set forth various embodiments of the devices and/or processes via the use of certain exemplary embodiments. Insofar as such embodiments contain one or more functions and/or operations, it will be understood by those skilled in the art that each function and/or operation within such embodiment can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Many of the methods described herein can be performed with variations. For example, many of the methods may include additional acts, omit some acts, and/or perform acts in a different order than as illustrated or described.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a housing;
an output;
a first motor arranged in the housing and coupled to the output;
a second motor arranged in the housing and coupled to the output; and
a differential gear system mechanically coupled between the first motor, the second motor, and the output,
the first motor configured to apply a first torque to the output via the differential gear system and the second motor configured to apply a second torque to the output via the differential gear system, the first torque being different than the second torque.

2. The device of claim 1 further comprising:
a first electronic controller coupled to the housing and in electronic communication with the first motor.

3. The device of claim 2 wherein the first electronic controller is configured to select a direction of the first torque output from the first motor.

4. The device of claim 1 further comprising:
a second electronic controller coupled to the housing and in electronic communication with the second motor.

5. The device of claim 4 wherein the second electronic controller is configured to select a direction of the second torque output from the second motor.

6. The device of claim 1 further comprising:
a handwheel coupled to the housing and mechanically coupled to the differential gear system.

7. The device of claim 1 further comprising:
a valve mechanically coupled to the output of the housing and configured to move between an open position and a closed position.

8. The device of claim 7 wherein the first motor is configured to output the first torque to the valve to seat the valve in the closed position and to unseat the valve from the closed position.

9. The device of claim 8 wherein the second motor is configured to output the second torque to the valve to move the valve between the closed position and the open position.

10. The device of claim 1 wherein the first motor and the second motor are configured to simultaneously apply the first torque and the second torque.

11. The device of claim 1 wherein the first torque corresponds to a first speed and the second torque corresponds to a second speed different from the first speed.

12. The device of claim 11 wherein the first torque is greater than the second torque and the first speed is less than the second speed.

13. A device, comprising:
a housing;
an output;
a first motor configured to produce a first torque in a first direction;
a second motor configured to produce a second torque that is different than the first torque in a second direction; and
a differential gear system arranged in the housing and mechanically coupled to the first motor, the second motor, and the output, the differential gear system configured to receive the first torque from the first motor and the second torque from the second motor, and apply a third torque in a third direction to the output.

14. The device of claim 13 wherein the first direction is opposite the second direction.

15. The device of claim 14, wherein the third direction is the first direction.

16. The device of claim 13 further comprising a first electronic controller coupled to the housing and in electronic communication with the first motor.

17. The device of claim 16, wherein the first electronic controller is in electronic communication with the second motor.

18. The device of claim 16 further comprising:
a second electronic controller coupled to the housing and in electronic communication with the second motor.

19. A device, comprising:
a valve;
a valve actuator that includes:
a housing;
an output coupled to the valve;
a first motor arranged in the housing and coupled to the output;
a second motor arranged in the housing and coupled to the output; and
a differential gear system in the housing and mechanically coupled between the first motor, the second motor, and the output.

20. The device of claim 19, wherein the first motor is configured to apply a first torque to the output via the differential gear system and the second motor is configured to apply a second torque to the output via the differential gear system, the first torque being different than the second torque.
